(19) United States
(12) Patent Application Publication
(10) Pub. No.: US 2006/0278100 A1
(43) Pub. Date: Dec. 14, 2006

(54) Seal for burners

(75) Inventors: Tomas Ekman, Saltsjo-Boo (SE); Anders Lugnet, Rimbo (SE)

Correspondence Address: ALFRED J MANGELS, 4729 CORNELL ROAD, CINCINNATI, OH, 452412433, US

(73) Assignee: AGA AB, Lidingo (SE)

(21) Appl. No.: 11/376,921

(22) Filed: Mar. 16, 2006

(30) Foreign Application Priority Data
Jun. 14, 2005 (SE) 0501347-9

(51) Int. Cl. A47J 37/07

(52) U.S. Cl. 99/450

(57) ABSTRACT

A seal for burners for the combustion of fossil fuels with an oxidant gas that contains a high fraction of gaseous oxygen. The burner includes a burner body with a cylindrical opening within which a cylindrical nozzle is removably positioned. The nozzle includes axial channels for the supply of fuel and oxidant gas. One, two or more parallel annular grooves are provided in the outer peripheral surface of the cylindrical nozzle. Each groove is arranged to support a sealing ring that is split or discontinuous at one location along its periphery. Each ring is arranged to lie in contact with the inner surface of the cylindrical opening when the nozzle is mounted in the burner body, with the discontinuities of the rings circumferentially offset relative to each other.

### BACKGROUND OF THE INVENTION

1. Field Of The Invention

The present invention relates to a seal for burners.

2. Description Of The Related Art

One of the solutions that is employed to solve the problem of NOₓ emissions from burners in industrial furnaces when burning fossil fuels is to inject oxygen gas at high velocity, wherein the oxygen gas has been mixed with the fuel outside of the burner.

The Swedish patent application number 0402223-2 describes an invention in which the concentration of oxygen in the combustion zone is lowered by the use of separation, high pressure, and an optimized location of nozzles, even though the oxidant has an oxygen concentration greater than 80%. That is achieved by locating the nozzles in a configuration that provides a large negative pressure on the surfaces of the nozzle that do not have nozzles for medium. Combustion gases are drawn in from the furnace atmosphere by suction as a result of the negative pressure, and are mixed in a rapid and turbulent manner with the media that flow out. The mixing medium, i.e., the atmosphere of the furnace, typically has an oxygen concentration of 0.5-10%. The remaining gases are CO₂ and H₂O and N₂ in various proportions.

The oxygen gas is injected through a multifunctional nozzle with several openings for the supply of oxygen gas. The high velocity is maintained by the use of a high oxygen gas pressure behind the nozzle.

The nozzle is mounted onto a cooled or non-cooled body, and must be simple to remove in order to be able to conduct service on it. The body, which has a hole for the nozzle and is normally denoted as the “burner,” is located during use in a furnace wall, and that means that the burner is exposed to high temperatures.

One problem is that of achieving a good seal between the nozzle and the surrounding burner body into which the nozzle has been inserted.

It may be sufficient in certain cases, in which the burner body is cooled, to construct the seal with an O-ring of rubber in the gap between the nozzle and the hole in the said burner body.

It has, however, proved to be the case for non-cooled burner bodies, but also for cooled burner bodies, that an O-ring seal is exposed to radiant heat from the furnace to such an extent that it has a short lifetime, and results in a poorer function of the burner.

The present invention solves the problem with a seal between the nozzle and the surrounding burner body.

### SUMMARY OF THE INVENTION

The present invention thus relates to a seal for burners for the combustion of fossil fuels with an oxidant gas that contains a high fraction of gaseous oxygen. The burner includes a burner body with a cylindrical opening within which a cylindrical nozzle is arranged such that it can be removed. The nozzle has axial channels for the supply of fuel and oxidant gas. One, two, or more parallel grooves are present in the outer surface of the cylindrical nozzle and extend around the periphery of the nozzle. Each groove is arranged to support a ring that is discontinuous at one location along its periphery, and each ring is arranged to lie in contact with the inner surface of the cylindrical hole when the nozzle is mounted in the burner body.

### BRIEF DESCRIPTION OF THE DRAWINGS

The structure, operation, and advantages of the present invention will become further apparent upon consideration of the following description, taken in conjunction with the accompanying drawings in which:

FIG. 1 shows schematically an axial cross-section of a portion of a burner body and a nozzle;

FIG. 2 shows schematically the burner body and nozzle as viewed from the right side of FIG. 1; and

FIG. 3 shows a side view of a ring, as viewed from the right side of FIG. 2 with one point of discontinuity.

### DESCRIPTION OF THE PREFERRED EMBODIMENTS

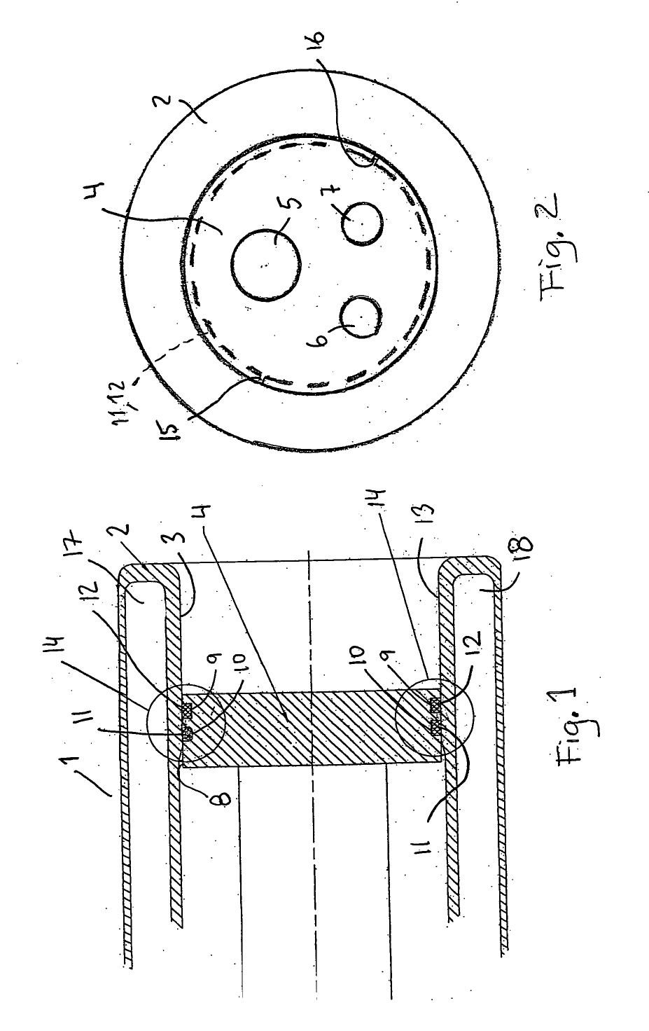

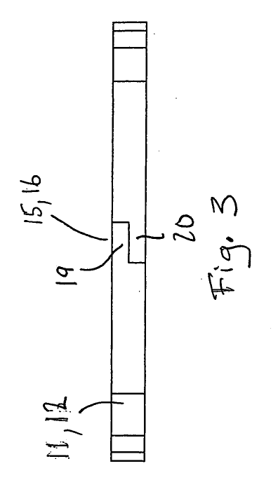

FIG. 1 shows a cross-section of a burner for the combustion of fossil fuel with an oxidant gas that contains a high fraction of gaseous oxygen. The content of gaseous oxygen preferably exceeds 80% by volume. The burner 1 includes a burner body 2 with a cylindrical opening 3 in which a cylindrical nozzle 4 has been arranged in a manner that allows its removal. As shown in FIG. 2, the nozzle has axial channels 5, 6, 7 for the supply of fuel and oxidant gas. Thus, the burner is of the type described in the above-mentioned patent application, and it is intended for the type of combustion described therein.

One, two (as shown in FIG. 2), or more parallel, annular grooves 9, 10 are, in accordance with the present invention, provided on the outer peripheral surface 8 of the cylindrical nozzle 4, and extend completely around the periphery of the nozzle. Furthermore, each groove 9, 10 is arranged to support an annular split ring 11, 12 that is radially discontinuous at a location along its periphery, to allow the ring to be circumferentially spread apart at the discontinuity.

Each groove and each ring are thus, in principle, constructed similar to the grooves and the piston rings, respectively, in a piston of an internal combustion engine. Each ring 11, 12 is arranged such that its outer peripheral surface is in contact with the inner surface 13 of the cylindrical opening 3 when the nozzle 4 is mounted in the burner body 2.

According to one preferred embodiment, the number of grooves and rings is two, as is shown within the circles 14 of FIG. 1.

The reference numbers 17, 18 in FIG. 1 denote cooling channels in the burner body 2.

In the case in which two or more rings are present, they are arranged, according to one preferred embodiment, such that the relative rotational position of the rings is such that the points of discontinuity of the rings do not each lie along the same straight line that is parallel to the longitudinal axis of the nozzle. The positions of the discontinuities 15, 16 of the rings 11, 12 are indicated in FIG. 2, which shows the respective discontinuities as circumferentially offset relative to each other, so as not to be aligned in an axial direction.

According to one preferred embodiment, each ring 11, 12 is manufactured from a spring grade of stainless steel.

The configuration of the discontinuities 15, 16 of the rings 11, 12 is illustrated in FIG. 3. According to one preferred embodiment, the discontinuities of each of the rings are designed as overlapping steps, such that each end of the discontinuity of the ring includes a circumferential step or protrusion 19, 20 that fits against and overlaps the protrusion at the opposite end of the ring in interengaged, contacting relationship when the ring is fully closed. The rings have dimensions such that when they are mounted in the grooves 9, 10 of the nozzle 4 and the nozzle is mounted in the burner body 2, the rings are essentially fully closed, with end protrusions 19, 20 interengaged as is shown in FIG. 3. A very tight seal is achieved in that way.

Through that interengagement and the metallic structure of the rings, a seal is obtained between the nozzle 4 and the cylindrical opening 3 that resists high temperatures and high pressures and that has a long operating lifetime. Furthermore, it is easy to remove the nozzle from the burner body for service of the nozzle and rings.

It is therefore clear that the present invention solves the problem that is described in the introduction above.

A number of embodiments have been described above. It is, however, clear that the number of rings and their relative locations can be varied, as can the design of the burner body.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A sealing arrangement for burners for the combustion of fossil fuels with an oxidant gas that contains a high fraction of gaseous oxygen, which sealing arrangement comprises: a burner body having a cylindrical opening in which a cylindrical nozzle is removably positioned, wherein the nozzle includes a plurality of axial channels for the passage of fuel and oxidant gas, at least one annular groove on an outer peripheral surface of the cylindrical nozzle, wherein the groove is arranged to support a split ring that is discontinuous at one location along its periphery, and wherein the ring is in contact with the inner surface of the cylindrical opening when the nozzle is mounted in the burner body.

2. A sealing arrangement in accordance with claim 1, wherein the number of rings and the number of annular grooves is at least two.

3. A sealing arrangement in accordance with claim 2, wherein the respective rings have such a rotational position relative to each other that respective discontinuities of the rings are not aligned along a straight line that is parallel with a longitudinal axis of the nozzle.

4. A sealing arrangement in accordance with claim 2, wherein each ring is made from a spring grade stainless steel.

5. A sealing arrangement in accordance with claim 3, wherein the discontinuity of each ring includes a protrusion at each end that engages with an opposite protrusion when the ring is fully closed, and wherein each ring has a size such that the rings are substantially fully closed when they are mounted in respective grooves of the nozzle and when the nozzle is mounted in the burner body.

6. A sealing arrangement in accordance with claim 5, wherein the protrusions at each end of the discontinuity are in overlapping relationship.
